(19) United States
(12) Patent Application Publication
(10) Pub. No.: US 2016/0054502 A1
(43) Pub. Date: Feb. 25, 2016

(54) LIGHT-EMITTING MODULE

(71) Applicant: BRIGHT LED ELECTRONICS CORP., NEW TAIPEI CITY (TW)

(72) Inventors: CHING-CHERNG SUN, NEW TAIPEI CITY (TW); TSUNG-JEN LIAW, NEW TAIPEI CITY (TW); JEN-TE CHEN, NEW TAIPEI CITY (TW); YU-HSIANG LIN, NEW TAIPEI CITY (TW); MING-YU HSU, NEW TAIPEI CITY (TW); TING-YUAN CHENG, NEW TAIPEI CITY (TW); YAO-CHI HSU, TAOYUAN COUNTY (TW); YI-CHIEN LO, TAOYUAN COUNTY (TW); XUAN-HAO LEE, TAOYUAN COUNTY (TW); MING-SHIOU TSAI, TAOYUAN COUNTY (TW)

(21) Appl. No.: 14/630,977

(22) Filed: Feb. 25, 2015

(30) Foreign Application Priority Data
Aug. 22, 2014 (TW) 103128907

(51) Int. Cl. F21V 8/00; G08G 1/095

(52) U.S. Cl. CPC G02B 6/0025; G02B 6/0061; G02B 6/0031; G02B 6/003; G02B 6/0073; G08G 1/095

(57) ABSTRACT

The present invention provides a light-emitting module, which comprises a light-emitting device, a light-guiding member, and an external light-guiding member. The light-emitting device emits light. The light-guiding member is disposed on the light-emitting path of the light-emitting module; the external light-guiding member is disposed on the light-emitting path of the light-emitting member. The light-guiding member distributes the light over the light-incidence surface of the external light-guiding member uniformly. After the external light-guiding member, the light is modified to axially symmetric light. Besides, the light-emitting device is disposed in a reflection ring, and a diffuser is disposed on the light-emitting path of the light-emitting device. When a minority of the light-emitting device fail, although the overall energy of the light source is reduced, the influence on the light emission of the light-emitting module is not significant. Thereby, the distribution of luminance will not differ significantly.

### FIELD OF THE INVENTION

The present invention relates generally to a light-emitting module, and particularly to a light-emitting module that uses combination of light-guiding members to enable uniform distribution of the luminance of the light-emitting surface of the light-emitting module.

### BACKGROUND OF THE INVENTION

Technologies advance day by day. Current domestic lighting generally adopts tungsten lamps or halogen lamps. For work, the lighting is fluorescent lamps. And for street lights, high-pressure sodium lamps are mostly adopted. Nonetheless, as technologies progress, most of the lighting equipment described above is gradually replaced by light-emitting diodes (LEDs). The light-emitting principle of LEDs lies on using the semiconductor technology to convert electrical energy into photo energy. They have advantages of small size, low power consumption, fast response, and long lifetime.

A traffic light is a normal apparatus in people's daily lives. There are light sources disposed in a traffic light. The signals for different colors of light alternate at a regulated period. It is a traffic regulating apparatus operated by electrical power. By using the red, yellow, and green colors of light, a traffic light is disposed at intersections or other required locations for guiding cars and pedestrians to stop, attend, and move. Accordingly, it is frequently used.

There are many issues by using LEDs as the light sources. One is that a single LED cannot satisfy lighting requirements. This is caused by the directivity of the emitted light. The luminance of a LED decreases as the light-emitting angle increases. Thereby, the problem of uneven luminance is generally present in LED bulbs.

There are many improvement methods according to the prior art, for example, the design concept of LED array. Nonetheless, their drawbacks include large size, high cost, bad heat dissipation for LEDs, or the requirement of increasing LED power for compensating insufficiency in luminance. Unfortunately, the design needs appropriate heat dissipation for avoiding damages in LED bulbs caused by inferior heat dissipation.

In addition, for street lights, traffic lights, or court lighting, the height of the light sources are much higher than normal lamps, leading to inconvenience in replacement, maintenance, and cleaning. LEDs have long lifetime; they do not need to be replaced frequently. Nonetheless, if the dusts are not cleaned periodically, the heat dissipating vent will be blocked. As a result, the heat will accumulate and cause light decay or burn-out of the LEDs. Accordingly, an LED structure is required currently for improving the problems caused by uneven luminance of LED bulbs.

In order to solve the drawbacks described above, the present invention provides a light-emitting module comprising a light-emitting device formed by LEDs. The light-emitting device emits light. Two light-guiding members are disposed on the light path of the light-emitting device. After the light passes through the two light-guiding members in the light-emitting module, it emerges from the light-emitting surface of the light-emitting module, and thus evening the distribution of luminance on the light-emitting surface of the light-emitting module. By using the above structure, it is not necessary to use massive LEDs for providing sufficient brightness. Besides, when a minority of the LEDs in the light-emitting device fail to function, the distribution of luminance will not differ significantly, although the overall energy of the light-emitting module is decreased. Thereby, the number of repair can be reduced.

### SUMMARY

An objective of the present invention is to provide a light-emitting module. Two light-guiding members are disposed on the light-emitting path inside the light-emitting device for evening the distribution of luminance on the light-emitting surface of the light-emitting module.

Another objective of the present invention is to provide a light-emitting module. A diffuser and a reflection ring are disposed in the light-emitting device. When a minority of LEDs in the light-emitting device fail, the influence on the light emission of the light-emitting module is not significant, although the overall energy of the light-emitting module is decreased. Thereby, the distribution of luminance will not differ significantly.

In order to achieve the objective and efficacies described above, the present invention provides a light-emitting module, which comprises a light-emitting device, a light-guiding member, and an external light-guiding member. The light-emitting device emits light. The light-guiding member is disposed on a diffuser and on the light-emitting path of the light-emitting device. The area of the light-emitting member is greater than the area of the diffuser. The light passes through the diffuser and produces scattered light. The light-guiding member modifies the distribution of the light intensity scattered from the diffuser to uniform distribution and guides it to the light-incidence surface of the external light-guiding member. The external light-guiding member is curved with an area greater than that of the light-guiding member and disposed on the light-emitting path of the light-guiding member. An axially symmetrical light is then provided by the external light-guiding member.

Furthermore, a reflection ring frames the light-emitting device, and the diffuser is disposed on the light-emitting path of the light-emitting device.

### BRIEF DESCRIPTION OF THE DRAWINGS

FIG. 1A shows a cross-sectional view of the light-emitting module according to the first embodiment of the present invention;

FIG. 1B shows a schematic diagram of the light path according to the first embodiment of the present invention;

FIG. 1C shows a structure of the light-guiding member according to the first embodiment of the present invention;

FIG. 1D shows a structure of the external light-guiding member according to the first embodiment of the present invention;

FIG. 1E shows a atomized-structure surface according to the second embodiment of the present invention;

FIG. 2A shows a cross-sectional view of the light-emitting module according to the third embodiment of the present invention;

FIG. 2B shows a schematic diagram of the light path according to the third embodiment of the present invention; and

FIG. 2C shows a atomized-structure surface according to the fourth embodiment of the present invention.

### DETAILED DESCRIPTION

In order to make the structure and characteristics as well as the effectiveness of the present invention to be further understood and recognized, the detailed description of the present invention is provided as follows along with embodiments and accompanying figures.

According to the prior art, a single LED cannot satisfy lighting requirements. This is caused by the directivity of the emitted light. The luminance of a LED decreases as the light-emitting angle increases. Thereby, the problem of uneven luminance is generally present in LED bulbs. There are many improvement methods according to the prior art, for example, the design concept of LED array. Nonetheless, their drawbacks include large size, high cost, bad heat dissipation for LEDs, or the requirement of increasing LED power for compensating insufficiency in luminance. Unfortunately, the design needs appropriate heat dissipation for avoiding damages in LED bulbs caused by inferior heat dissipation. In addition, the above light sources are formed by LEDs. As a minority of the LEDs fail to function, whether the distribution of luminance will differ significantly or the light will be insufficient has become another major issue.

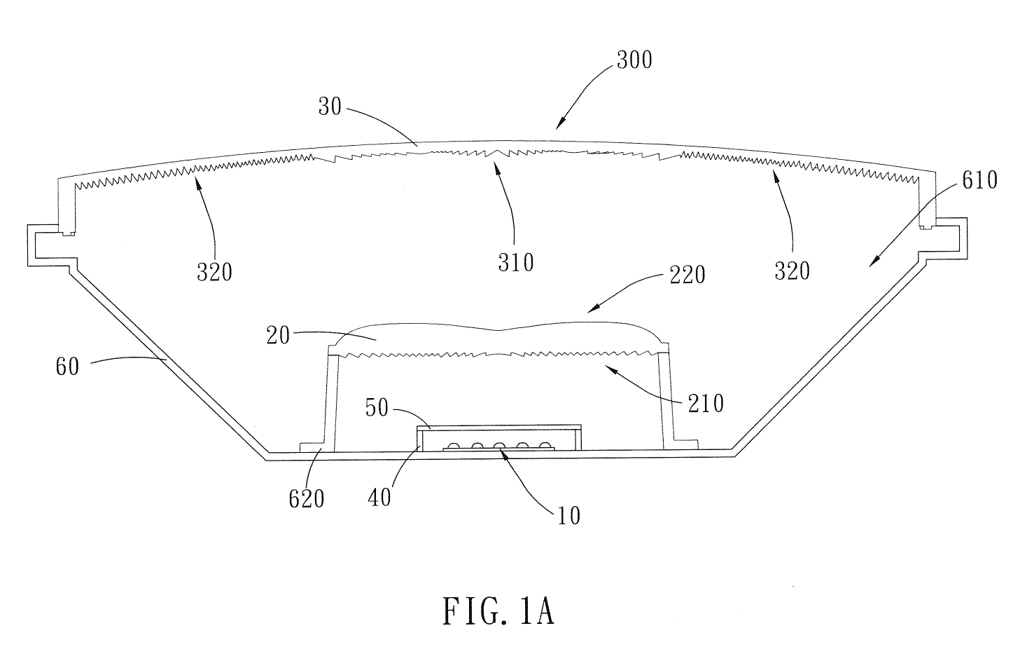

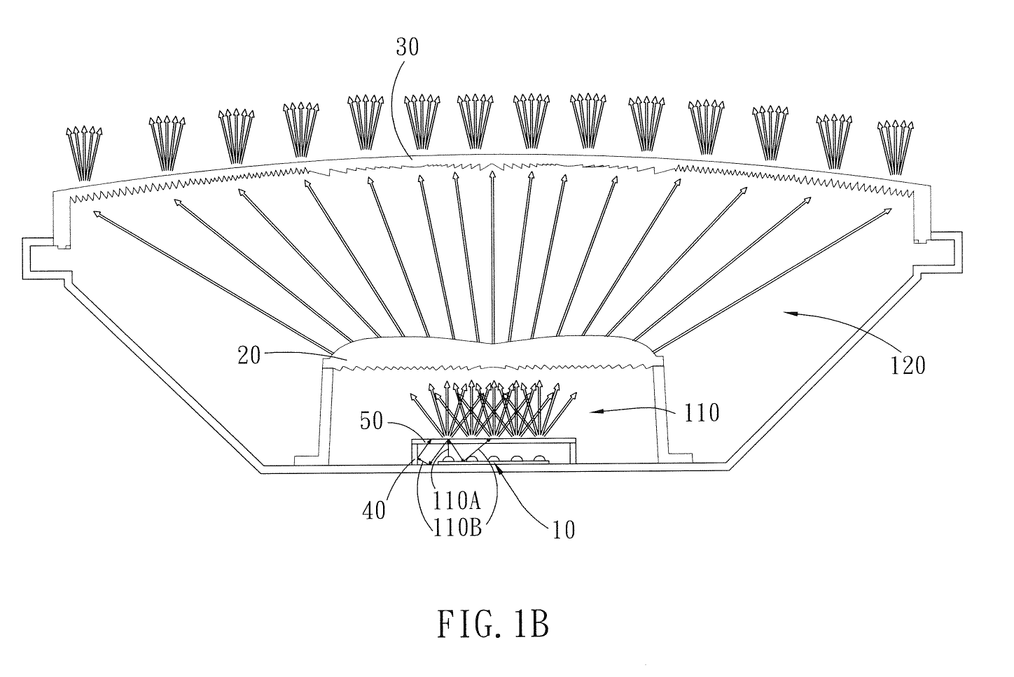

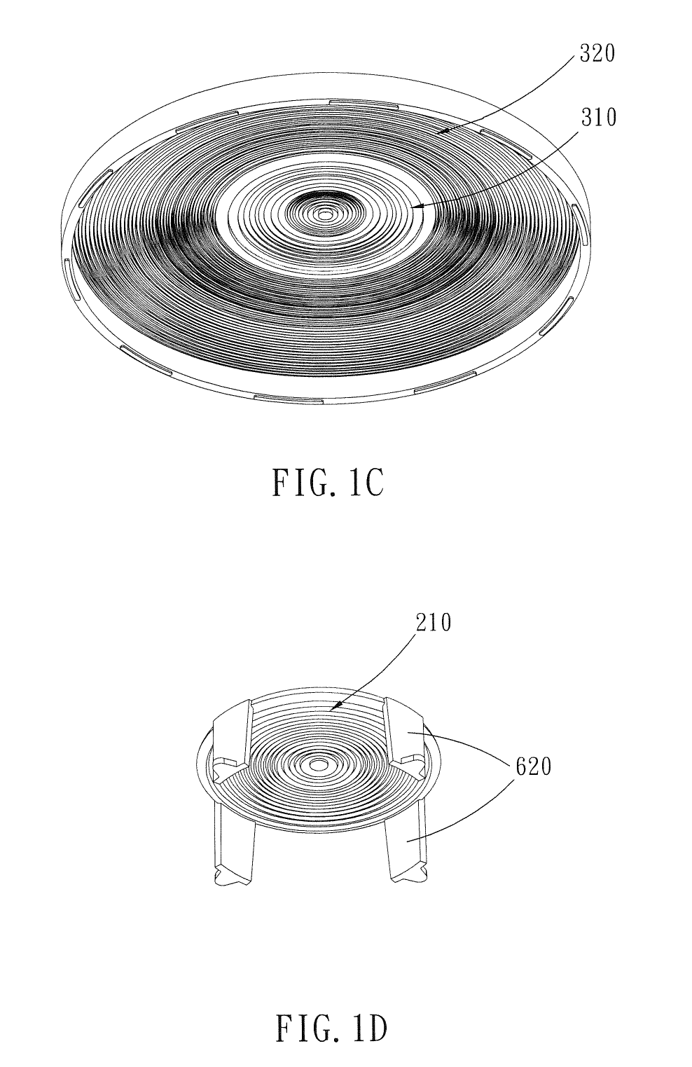

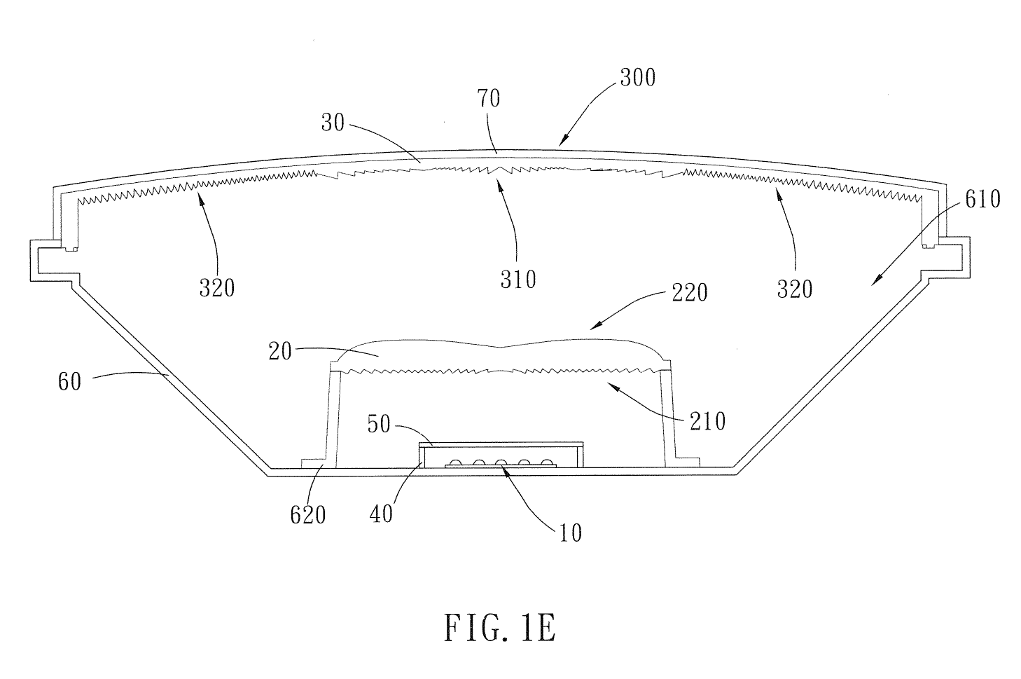

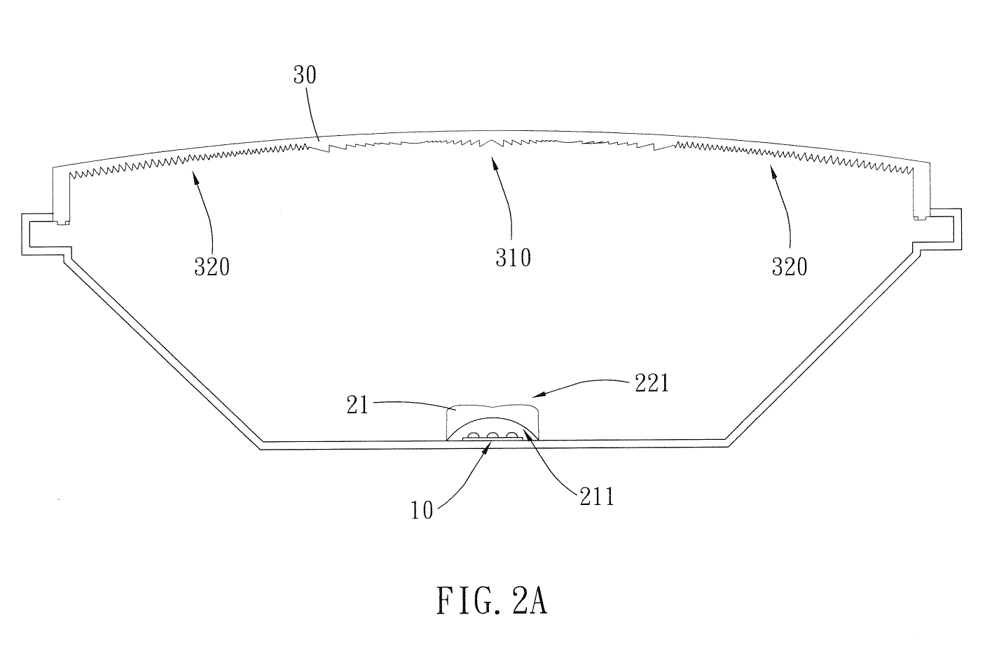

Refer to FIGS. 1A to 1D, it show a cross-sectional view of the light-emitting module, a schematic diagram of the light path, a structure of the light-guiding member, and a structure of the external light-guiding member according to the first embodiment of the present invention. As shown in the FIGS. 1A to 1D, the present embodiment provides a light-emitting module, which comprises a light-emitting device 10, a light-guiding member 20, and an external light-guiding member 30. The present embodiment includes a housing 60, which includes an accommodating space 610. The light-emitting device 10 is disposed at the bottom of the accommodating space 610. A plurality of supporting member 620 are disposed at the bottom of the accommodating space 610 and surrounding the light-emitting device 10. The light-guiding member 20 is disposed on the plurality of supporting members 620. The light-guiding member 20 is located on the light-emitting device 10. Besides, the external light-guiding member 30 is disposed at the opening of the accommodating space 610.

Then, the light-emitting device 10 emits scattered light 110 through a diffuser 50. The light-guiding member is disposed on the light-emitting path of the light-emitting device 10 with an area greater than the illumination area of the light-emitting device 10. The scattered passes through the light-guiding member 20 and produces uniform light 120 with even distribution of light energy. The external light-guiding member 30 is curved with an area greater than that of the light-guiding member 20. The external light-guiding member is disposed on the light-guiding path of the light-guiding member 20. Thereby, after the uniform light having even distribution of light energy passes through the light-guiding member 20, the light-guiding member 20 will distribute the uniform light having even distribution of light energy to the light-incidence surface of the external light-guiding member 30 uniformly. Thereby, after the external light-guiding member 30, axially symmetrical light is provided. The axially symmetrical light satisfies the requirement of light distribution for the application of traffic lights. In addition, the distribution of luminance of the light on the light-emitting surface of the external light-guiding member 30 is uniform.

Refer to FIGS. 1C and 1D concurrently. The present embodiment is mainly applied to large light-emitting device structures. The light-emitting device 10 according to the present embodiment is a COB surface light source (a light source with an array of chips arranged in a single package) or an array of LED light sources. The light-incidence surface of the light-guiding member 20 has a refractional structure comprising a plurality of annular grooves 210 formed by concentric circles with different sizes. The cross-sectional view of each annular groove 210 shows a zigzag structure. The function of the light-guiding member 20 is to scatter the light of the light-emitting device 10 for enlarging the illumination range of the light. In addition, the light-emitting surface of the light-guiding member 20 is a smooth curved surface 220, which is a structure with a concave center and a convex periphery.

Moreover, the light-incidence surface of the external light-guiding member 30 has a plurality of annular grooves 300, which is formed by concentric circles with different sizes and includes a refractional-structure surface 310 and a total-reflection-structure surface 320 disposed on the periphery of the refractional-structure surface 310. The cross-sectional view of each annular groove 300 shows a zigzag structure. The angles of the apex of the zigzag structure of the refractional-structure surface 310 are larger and the density of the apexes is loose. Thereby, there will no excess shift in the direction of the uniform light 120 illuminating on the refractional-structure surface 310 located at the center. As a consequence, the uniform light 120 with even distribution of light energy can illuminate in the same direction evenly and concentratively. Conversely, the angles of the apex of the zigzag structure of the refractional-structure surface 310 are smaller and the density of the apexes is tight. Thereby, the uniform light 120 with even distribution of light energy illuminating on the total-reflection-structure surface 310 located on the periphery can calibrate larger angles. Consequently, the uniform light 120 with even distribution of light energy can illuminate in the same direction evenly and concentratively. In addition, the light-emitting surface of the external light-guiding member 30 is a smooth curved surface 330, which is a curved-surface structure having a higher center and a lower periphery.

The light-emitting device 10 according to the present invention further comprises a reflection ring 40 and a diffuser 50. The reflection ring 40 is disposed at the bottom of the accommodating space 610, and the light-emitting device 10 is disposed inside the reflection ring 40. The diffuser 50 is disposed on the reflection ring 40 such that the diffuser 50 is located between the light-emitting device 10 and the light-guiding member 20. When the light of the light-emitting device 10 illuminates the diffuser 50, part of the light of the light-emitting device 10 will pass through the diffuser 50 directly and produce the scattered light 110A. The other part thereof is reflected to the bottom surface of the accommodating space 610 or the inner sidewall of the reflection ring 40 by the diffuser 50 and then reflected to the diffuser 50, leading the production of the reflection light 110B. Both rays of light, the scattered light 110A and the reflection light 110B after scattering, are combined to the scattered light 110 after passing the diffuser 50. Thereby, the distribution of the light intensity on the light-emitting surface of the diffuser 50 is more uniform. If the light-emitting device 10 is a COB light source or an array of LED light sources and as a portion of the LEDs or LED chips fails, the influence on the uniformity of the distribution of luminance on the overall light-emitting surface of the light-emitting module, namely, the light-emitting surface of the external light-guiding member 30, is less, although the overall energy of the light source is reduced.

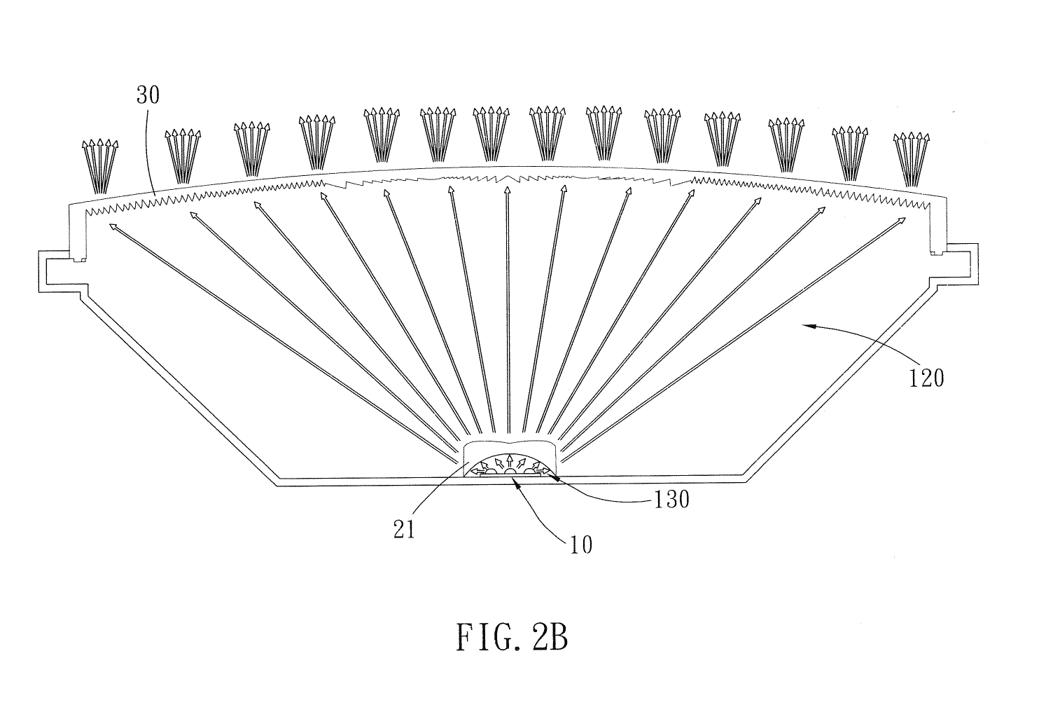

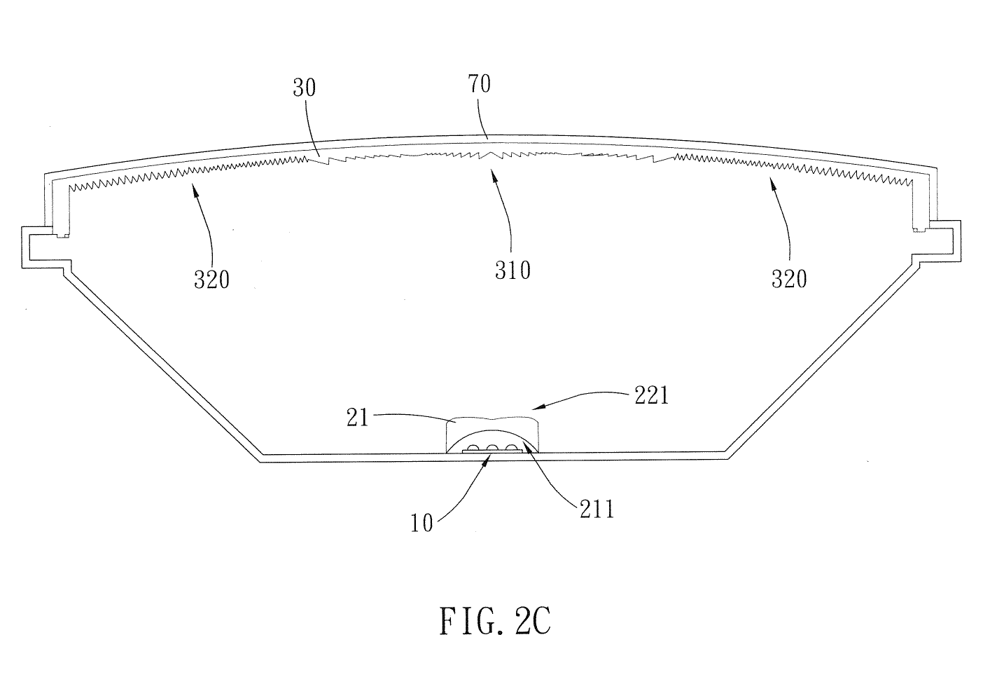

Refer to FIG. 1E, it shows an atomized-structure surface according to the second embodiment of the present invention. As shown in the FIG. 1E, the difference between the first embodiment and the present one is that an atomized-structure surface 70 is disposed on the overall light-emitting surface of the light-emitting module, namely, the light-emitting surface of the external light-guiding member 30. The light-emitting surface on the external light-guiding member 30 is formed as the atomized-structure surface 70, such as texture structure surface or rough structure surface, by friction. Furthermore, a mold of the external light-guiding member 30 is manufactured without any polishing, resulting in the surface of the external light-guiding member 30 will be a roughness surface as atomization. In addition, a diffuser sticker is disposed on the light-emitting surface of the external light-guiding member 30 as atomization. The above-described manner is applied for disposing the atomized-structure surface 70 on the light-emitting surface of the external light-guiding member 30 according to the present invention. The light intensity distribution of the light-emitting surface on the external light-guiding member 30 is arranged evenly. The effect of the atomized-structure surface 70 is the same as the effect of the diffuser 50. Thereby, the effect of the diffuser 50 will be no more description. The manufacturing manner of the atomized-structure surface 70 is not limited to above detailed description of the present invention. The present invention is directed to any atomizing effect for source passing through the atomized-structure surface 70 can make the light intensity distribution arranged evenly. Refer to FIG. 2A and FIG. 2B, it show a cross-sectional view of the light-emitting module and a schematic diagram of the light path according to the second embodiment of the present invention. As shown in the FIGS. 2A and 2B, the difference between the first embodiment and the present one is that a smaller light-emitting device 10 is adopted in the present embodiment. An internal light-guiding member 21 according to the present embodiment covers the light-emitting device 10. The light-incidence surface of the internal light-guiding member 21 is a refractional-structure surface 211, while the light-emitting surface of the internal light-guiding member 21 is a smooth curved surface 221 having a convex periphery and a concave center. After the light 130 of the light-emitting device 10 passes through the internal light-guiding member 21, the angular distribution of the energy of the light 130 is uniformized. Then the light 130 is scattered to produce uniform light 120 and illuminate on the external light-guiding member 30. The internal light-guiding member 21 distributes the light 130 evenly over the light-incidence surface of the external light-guiding member 30. The effect of the external light-guiding member 30 is identical to that in the first embodiment. Hence, the details will not be described again.

Refer to FIG. 2C, it shows an atomized-structure surface according to the second embodiment of the present invention. As shown in the FIG. 2C, the difference between the third embodiment and the present one is that an atomized-structure surface 70 is disposed on the overall light-emitting surface of the light-emitting module, namely, the light-emitting surface of the external light-guiding member 30. And the atomized-structure surface 70 is the same as the second embodiment of the present invention. Thereby, the effect of the atomized-structure surface 70 will be no more description. To sum up, the present invention provides a light-emitting module. Two light-guiding members are disposed on the light-emitting path of the light-emitting device according to the present invention. When the light passes through the first light-guiding member, the light is scattered and thus increasing the original illuminating range. Then the light passes through the second light-guiding member for uniformizing and concentrating in the same direction of illumination. Thereby, the distribution of the luminance fro, the light-emitting surface of the light-emitting module can be uniform. Afterwards, by using the diffuser and the reflection rang disposed in the light-emitting device, the space formed by the diffuser and the reflection rang circulates the light therein. As a minority of the LEDs in the light-emitting device fail, although the overall energy of the light source is reduced, the influence on light emission is not significant. Hence, the distribution of luminance will not differ excessively. The atomized-structure surface on the light-emitting surface of the external light-guiding member according to the present invention. The light intensity distribution of the light-emitting surface on the external light-guiding member is arranged evenly.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

1. A light-emitting module, comprising:
a light-emitting device;
a reflection ring, framing said light-emitting device;
a diffuser, disposed on said reflection ring, and located on the light-emitting path of said light-emitting device;
a light-guiding member, disposed on said diffuser and on the light-emitting path of said light-emitting device, the area of said light-emitting member greater than the area of said diffuser, the light of said light-emitting device passing through said diffuser and producing scattered light to the light-incidence surface of said light-guiding member; and
an external light-guiding member, having a curved shape, having an area greater than said light-guiding member, disposed on the light-emitting path of said light-guiding member, said light-guiding member producing and distributing uniform light with even energy distribution to the light-incidence surface of said external light-guiding member, and said uniform light with even energy distribution passing through said external light-guiding member and providing axially symmetrical light.

2. The light-emitting module of claim wherein said light-emitting device is a COB surface light source (a light source with an array of chips arranged in a single package) or an array of LED light sources.

3. The light-emitting module of claim 1, wherein the light-incidence surface of said light-guiding member is a refractional-structure surface.

4. The light-emitting module of claim 1, wherein the light-incidence surface of said external light-guiding member comprises a refractional-structure surface and a total-reflection-structure surface, and said total-reflection-structure surface is disposed on the periphery of said refractional-structure surface.

5. The light-emitting module of claim 1, wherein the light-emitting surface of the external light-guiding member disposed on a atomized-structure surface.

6. A light-emitting module, comprising:
a light-emitting device, emitting light;
an internal light-guiding member, disposed on the light-emitting path of said light-emitting device; and
an, external light-guiding member, having a curved shape, said internal light-guiding member having an area smaller than said external light-guiding member, disposed on the light-emitting path of said internal light-guiding member, said internal light-guiding member producing and distributing uniform light with even energy distribution to the light-incidence surface of said external light-guiding member, and said uniform light with even energy distribution passing through said external light-guiding member and providing axially symmetrical light.

7. The light-emitting module of claim 6, wherein said internal light-guiding member covers the light-emitting path of said light-emitting device.

8. The light-emitting module of claim 6, wherein said light-emitting device is a COB surface light source.

9. The light-emitting module of claim 6, wherein the light-incidence surface of said internal light-guiding member is a refractional-structure surface.

10. The light-emitting module of claim 6, wherein the light-incidence surface of said external light-guiding member comprises a refractional-structure surface and a total-reflection-structure surface, and said total-reflection-structure surface is disposed on the periphery of said refractional-structure surface.

11. The light-emitting module of claim 6, wherein the light-emitting surface of the external light-guiding member disposed on a atomized-structure surface.
